(19) United States
(12) Patent Application Publication
(10) Pub. No.: US 2009/0102207 A1
(43) Pub. Date: Apr. 23, 2009

(54) Automatic Stopper Apparatus

(76) Inventor: Yon Hee Kim, Gyeonggi-do (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/299,030

(22) PCT Filed: May 2, 2006
(86) PCT No.: PCT/KR2007/002151

§ 371 Date: Oct. 30, 2008

(30) Foreign Application Priority Data
May 2, 2006 (KR) 10-2006-0039492

(51) Int. Cl. E05C 17/44

(52) U.S. Cl. 292/338

(57) ABSTRACT

An automatic stopper apparatus includes a control box buried in an inner side of a door, an opening sensor arranged in a predetermined portion of the door, a drive box buried in the inner side of the door and a stopper having a body having a split central portion and opposing first and second ends. The control box has a battery unit and a circuit board therein, and the battery unit includes a plurality of batteries arranged therein. The opening sensor is electrically connected to the circuit board, and the drive box is electrically connected with the circuit board of the control board, and driven by a motor which performs forward/backward rotation. A driven medium is connected to the drive medium, an elastic spring is arranged inside the body, and a door fixing member is arranged at the second end of the body.

### TECHNICAL FIELD

The present invention relates to an automatic stopper apparatus used in a door or an automatic door stopper apparatus.

### BACKGROUND ART

In general, a door stopper apparatus, which is also referred to as a horseshoe, is arranged in a hinged door and used to fix the door in an opened position. The door stopper apparatus is used to stop or fix the hinged door by flipping down a horseshoe-shaped stopper in a case where the door has to be opened for a time being because of a large number of customers entering and exiting, products carried in and out, or a cleaning or ventilation performed.

FIG. 1 is a schematic perspective view illustrating a door stopper apparatus of the prior art.

Referring to FIG. 1, a conventional door stopper apparatus includes a stopper 100 and a base plate 200. The base plate 200 has a plurality of fixing holes 220 to be bolt connected to a door. The base plate 200 also has guide plates 320 and 340, which are protruded therefrom with hinge holes 330. The stopper 100, which is also referred to as a horseshoe, is pivotably arranged between the guide plates 320 and 340. The stopper 100 has a body 180 extending to a predetermined length, when viewed from a side thereof. The thickness of the stopper 100 is substantially the same as the gap between the guide plates 320 and 340. A door fixing member 160 made of rubber is integrally equipped at the bottom end of the body 180 to fix the door to the ground. The stopper 100 has a pivoting part 150 equipped at the top end thereof, a contact protrusion 140 arranged at one portion of the pivoting part 150 and a through hole 120 formed in the center of the pivoting part 150. The through hole 120 is interposed between the hinge holes 330 of the guide plates 320 and 340 to be maintained coaxial with the hinge holes 330. In this way, the stopper 100 is pivotably arranged between the guide plates 320 and 340, by means of a hinge shaft 400 having an anti-release protrusions 420 formed at both ends thereof.

### DISCLOSURE OF THE INVENTION

However, in the conventional door stopper apparatus having the aforementioned structure, it is inconvenient for a user to bend his/her waist to manipulate the horseshoe-shaped stopper with the hand in order to move up and down the stopper. Furthermore, since it needs a skill to move up and down the stopper of the con-ventional door stopper apparatus, those people including elders, feeble persons, children and females generally evade from operating the stopper. In particular, the handicapped and the aged cannot bend their waist to manipulate the stopper, and those who sit on a wheelchair also cannot easily manipulate the stopper.

The conventional door stopper apparatus is sometimes manipulated by the foot.

However, this may exert an excessive force to the stopper thereby breaking the stopper or cause dust or dirt to stick from the stopper to a shoe of the user.

### TECHNICAL SOLUTION

The present invention has been made to solve the foregoing problems of the prior art and therefore an aspect of certain embodiments of the present invention is to provide an automatic door stopper apparatus having a stopper which can be easily operated by any user including the handicapped.

Another aspect of the invention is to provide an automatic door stopper apparatus having an improved stopper structure in order to prevent a door from being closed by an external force such as aspect wind.

Further another object of the invention is to provide an automatic door stopper apparatus which is applicable to not only a hinged door but also a sliding door and a glass door.

According to an aspect of the invention, the automatic door stopper apparatus includes a control box buried in an inner side of a door, the control box having a battery unit and a circuit board therein, the battery unit including a plurality of batteries arranged therein; an opening sensor arranged in a predetermined portion of the door and electrically connected to the circuit board; a drive box buried in the inner side of the door and electrically connected with the circuit board of the control board, the drive box driven by a motor which performs forward/backward rotation; and a stopper having a body having a split central portion and opposing first and second ends, a driven medium arranged at the first end of the body and connected to the drive medium, an elastic spring arranged inside the body, and a door fixing member arranged at the second end of the body.

Preferably, the control box and the drive box may be arranged on an inner side of the door to be exposed therefrom.

Preferably, the drive medium may comprise one selected from the group including a spur gear, a wire and a pinion, and wherein the driven medium comprises one selected from the group including a gear meshing with the spur gear, a connector connected with the wire and a rack meshing with the pinion.

Preferably, the door may comprise one selected from the group consisting of a hinged door, sliding door and a glass door, and wherein the battery unit and the circuit board are integrally arranged in the drive box.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic perspective view illustrating a door stopper apparatus of the prior art;

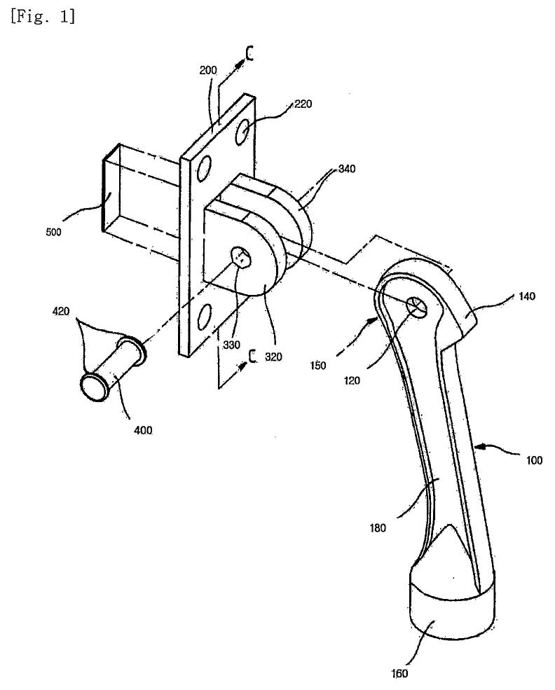

FIG. 2 is a front configuration view illustrating an automatic door stopper apparatus according to an embodiment of the invention;

FIG. 3 is a perspective view illustrating the automatic door stopper apparatus of the invention;

FIG. 4 is a side configuration view illustrating an operational status of the automatic door stopper apparatus of the invention;

FIG. 5 is a side configuration view illustrating an automatic door stopper apparatus according to another embodiment of the invention;

FIG. 6 is a side configuration view illustrating another embodiment of the drive medium and the driven medium in the automatic door stopper apparatus of the invention;

FIG. 7 is a side configuration view illustrating further another practical embodiment of the drive medium and the driven medium in the automatic door stopper apparatus of the invention;

FIG. 8 is a perspective view illustrating an automatic door stopper apparatus having an integral structure of a control box and a drive box according to further another embodiment of the invention;

FIG. 9 is a front configuration view illustrating the automatic door stopper apparatus having an integral structure of a control box and a drive box according to further another embodiment of the invention;

FIG. 10 is a perspective view illustrating an automatic door stopper apparatus having an integral structure of a control box and a drive box according to yet another embodiment of the invention; and

FIG. 11 is a front configuration view illustrating the automatic door stopper apparatus having an integral structure of a control box and a drive box according to yet another embodiment of the invention.

### BEST MODE

The present invention will now be described more fully with reference to the accompanying drawings, in which preferred embodiments of the invention are shown.

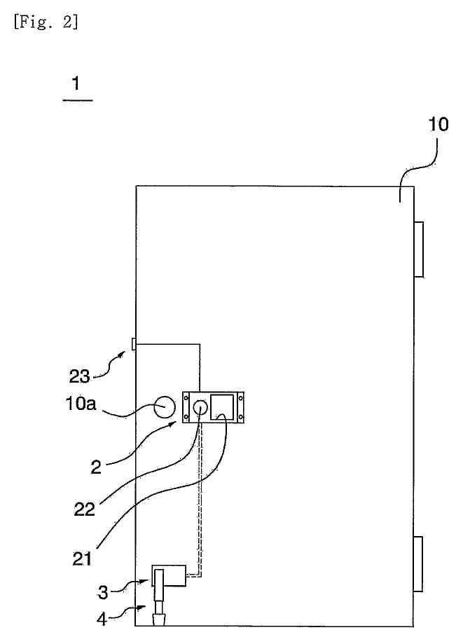

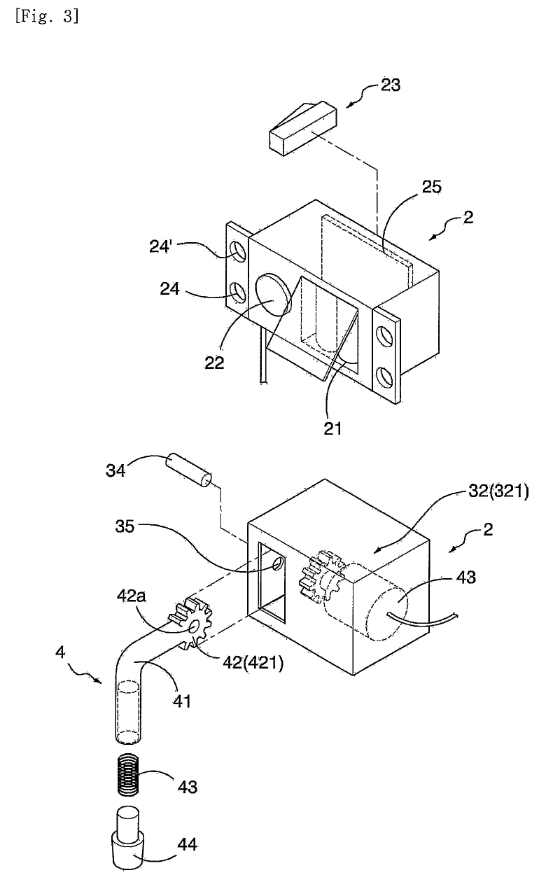

FIG. 2 is a front configuration view illustrating an embodiment of an automatic door stopper apparatus 1 of the invention, and FIG. 3 is a perspective view illustrating the automatic door stopper apparatus 1 of the invention.

Referring to FIGS. 2 and 3, the door stopper apparatus 1 of the invention includes a control box 2, an opening sensor 23, a drive box 3 and a stopper 4.

The control box 2 is arranged in a predetermined portion of an inner side of a door, in particular, a hinged door 10. Specifically, the control box 2 is buried in a predetermined portion of the hinged door 10 adjacent to a door knob 10a. To stably fix the control box 2, fixing flaps 24 with fixing holes 241 are protruded from both ends of the control box 2. A control button 22 and a battery unit 21 including a plurality of batteries are provided in a front portion of the control box 2, and a circuit board 25 is arranged inside the control box 2. Preferably, an openable door can be equipped in the battery unit 21 so that the batteries can be selectively replaced. The circuit board 25 is electrically connected to the opening sensor 23 such as a limit switch, which is arranged in an edge of the hinged door 10. According to this configuration of the control box 2, the opening sensor 23 detects an opening of the hinged door 10 and transmits a detection signal to the circuit board 25, which then externally supplies an electric power from the battery unit 21. The circuit board 25 also supplies the electric power from the battery unit 21 in response to a push of the control button 22. Accordingly, the circuit board 25 is equipped with a circuit structure capable to realizing these operations.

The control box 3 is arranged in a predetermined portion of an inner side of the hinged door 10, and more particularly, buried in a lower portion of the hinged door 10 where a typical stopper is arranged. A motor 31 electrically connected to the control box 2 and a drive medium 32 mounted on a shaft of the motor 31 are arranged inside the drive box 3. Preferably, the motor 31 is implemented with a motor capable of performing forward and backward rotations, and the drive medium 321 is implemented with a spur gear 321. The drive box 3 has a through hole 33 in a front portion thereof, for connection with the stopper 4. A pin hole 35 is formed adjacent to the through hole 33 for connection with a pin 34. According to this configuration, the motor 31 of the drive box 3 performs forward and backward rotations with the electric power fed from the control box 2.

The stopper 4 has a body 41, a driven medium 42 arranged at one end of the body 41 connected to the drive medium 31 and a door fixing member 44 made of rubber and arranged at the other end of the body 41. The body 41 has a split structure in a central portion thereof, and an elastic spring (compression spring) 43 is installed inside the central portion of the body 41. The driven medium 42 has a gear 421 meshing with the spur gear 321 of the drive medium 32 and a pin hole 42a formed in the center of the gear 421 to fix the pin 34. According to this configuration, the driven medium 42 of the stopper 4 is meshed with the drive medium 32 so that the stopper 4 is vertically pivoted or rotated in accordance with the actuation of the motor 31.

Now a description will be made of the operational status of the door stopper of the invention having the aforementioned structure.

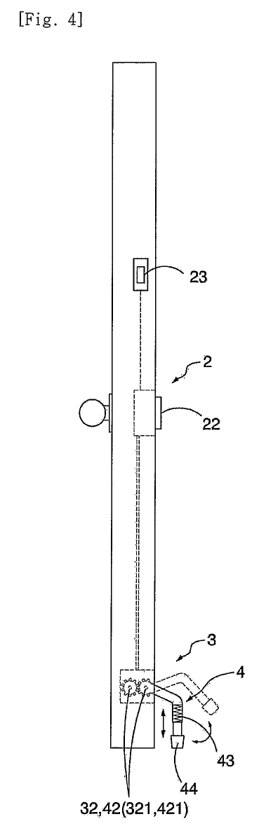

FIG. 4 is a side configuration view illustrating an operational status of the automatic door stopper apparatus of the invention.

Referring to FIG. 4, in the automatic door stopper apparatus 1 of the invention, when the hinged door 10 is opened, the opening sensor 23 detects the opening of the door 10 and then transmits a detection signal to the circuit board 25 of the control box 2. The circuit board 25 transmits an electric power from the battery unit 21 to the motor 31 of the drive box 3 to make the motor 31 rotate forward. As the spur gear 321 of the drive medium 32 rotates following the forward rotation of the motor 31, the rotation of the spur gear 321 is transmitted to the gear 421 of the driven medium 42, thereby pivoting or rotating the stopper 4 to move downward. That is, the automatic door stopper apparatus 1 of the invention operates in such a fashion that the stopper 4 automatically moves downward to support the door 10 when a user opens the hinged door 10. In this case, the door fixing member 44 arranged at the other end of the stopper 4 closely contacts the floor to prevent the stopper 4 from slipping, and the elastic spring 43 arranged inside the central portion of the body 41 of the stopper 4 transmits a widening force to the door fixing member 44 to prevent the opened door 10 from be closed by the wind and the like. In addition, the gear 421 of the driven medium 42 of the stopper 4 stands meshed with the spur gear 321 of the drive medium 32, thereby preventing the opened door from being closed by an external force.

When the user presses the control button 22 of the control box 2 in order to raise the stopper 4 supporting the door 10, the circuit board 25 transmits an electric power from the battery unit 21 to the motor 31 of the drive box 3 to make the motor 31 rotate backward. Then, the backward rotation of the motor 31 makes the spur gear 321 of the drive medium 32 rotate backward. The backward rotation of the spur gear 321 is also transmitted to the gear 421 of the driven medium 42 to pivot or rotate the stopper 4 upward. That is, the automatic door stopper apparatus 1 operates to raise the stopper 4 in response to a simple operation of the user pressing the control button 22.

Accordingly, the automatic door stopper apparatus 1 of the invention can overcome difficulties of the prior art by operating the stopper 4 in response to a simple operation of the user opening the door 10 or pressing the control button 22, and thus can be conveniently used by any users.

In the meantime, the automatic door stopper apparatus of the invention can be applied to a glass door in addition to the hinged door as illustrated in the drawings. That is, since the existing glass door is configured to remain opened only when it is opened to 90 degrees, it is possible to fix the glass door at an angle smaller than 90 degrees by adopting the invention. In this case, the control box and the drive box may be installed in a steel plate in the bottom of the glass door, the battery unit and the circuit board are equipped inside the drive box, and the control button is mounted on a predetermined portion of a knob of the glass door. According to this configuration, even when applied to the glass door, the automatic door stopper apparatus of the invention can realize the same operation and effects as for the hinged door. Mode for the Invention

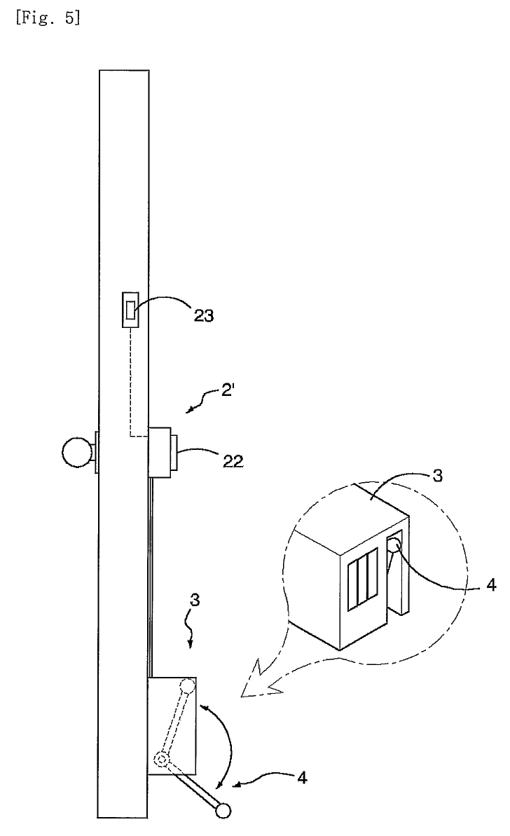

FIG. 5 is a side configuration view illustrating an automatic door stopper apparatus 1 according to another embodiment of the invention.

Referring to FIG. 5, the automatic door stopper apparatus 1 of the invention has a control box 2′ and a drive box 3′ mounted on an inner side of a hinged door 3′ to be exposed therefrom. In addition, a stopper 4 is journaled or pin-connected to a side portion of the drive box 3′, in which the inner space of the drive box 3′ may be enlarged to receive the stopper 4 therein when the stopper 4 is raised. Furthermore, the stopper 4 may have a linear body or like. The automatic door stopper apparatus 1 according to this embodiment is configured to be applied to an existing door such as a hinged door and a glass door. When the automatic door stopper apparatus 1 is applied to the hinged door, a finishing material (not shown) is preferably applied to electric cables for electrically connecting the control box 2′ and the drive box 3′. When the automatic door stopper apparatus 1 is applied to the glass door, it is preferable that a battery unit and a circuit board are arranged in the drive box 3′, a control button is mounted on a predetermined portion of a knob of the glass door, and a finishing material is applied to electric cables for electrically connecting the circuit board and the control button.

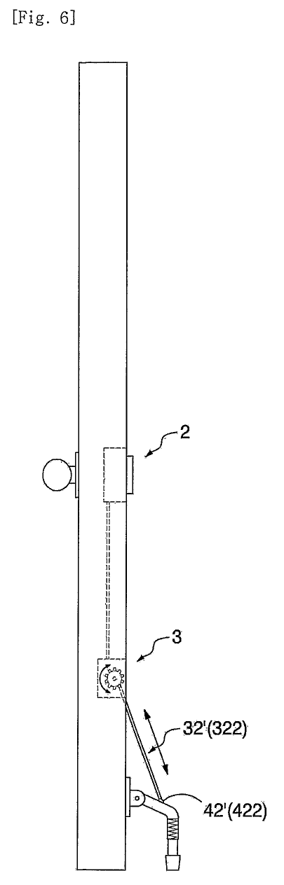

FIG. 6 is a side configuration view illustrating another embodiment of the drive medium and the driven medium in the automatic door stopper apparatus of the invention.

Referring to FIG. 6, in the invention, a wire 322 is connected at one end to the drive medium 32′ of the drive box 3, and at the other end, to a hooked connector 422 is applied to the driven medium 42′ of the stopper 4. In this case, the motor 31 in the drive box 2 is a one-way motor, and a winding drum (not shown) for winding the wire 322 is connected to a rotation shaft of the motor 31. The aforementioned opening sensor 23 is omitted. According to this configuration, the door stopper apparatus 1 using the wire 322 as a drive medium can be applied, particularly, to a hinged door, in which the stopper 4 is moved down manually but raised by the wire 322 using the motor 31 actuated in response to a push of the control button 22.

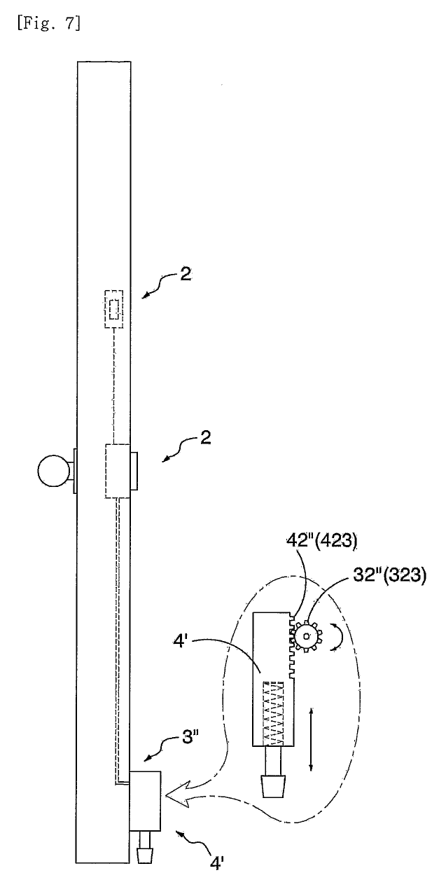

FIG. 7 is a side configuration view illustrating further another embodiment of the drive medium and the driven medium in the automatic door stopper apparatus of the invention.

Referring to FIG. 7, a drive medium 32 according to this embodiment of the invention has a pinion 323 axially connected with the motor 31, and a driven medium 42 has a rack 423 meshing with the pinion 323. According to this configuration of the drive and driven media 32 and 42, the rack 423 of the driven medium 42 converts a rotational movement into a linear movement to elevate or move up and down a stopper 4′. In this case, the automatic door stopper apparatus with the stopper 4′ elevating up and down can be applied to not only a hinged door but also a sliding door.

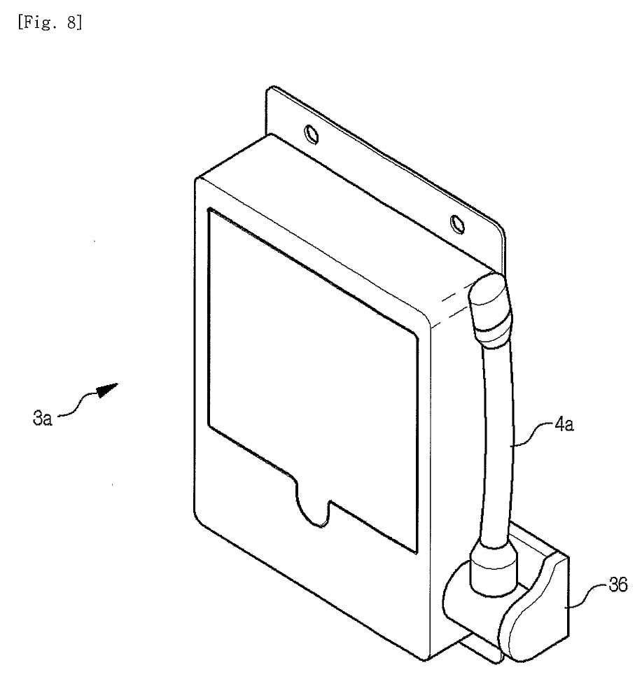

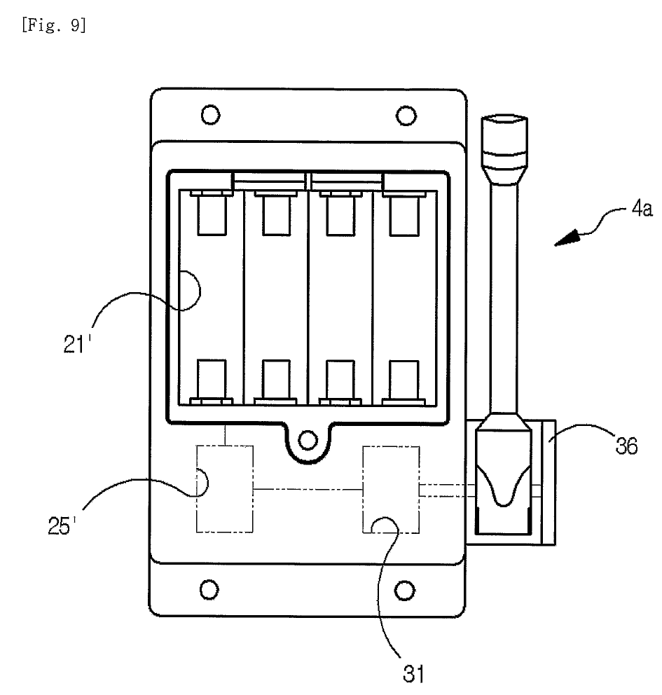

FIG. 8 is a perspective view illustrating an automatic door stopper apparatus having an integral structure of a control box and a drive box according to further another embodiment of the invention, and FIG. 9 is a front configuration view illustrating the automatic door stopper apparatus having an integral structure of a control box and a drive box according to further another embodiment of the invention.

Referring to FIGS. 8 and 9, this embodiment can provide integrate a control box with a drive box 3a by arranging a battery unit 21′ and a circuit board 25′ inside the drive box 3a and mounting a control button (not shown) on a predetermined portion of a door knob. In addition, a stopper 4a has one end of a body thereof, which is received in a receiver 36 extending from a lower portion of the drive box 3a and directly connected with a shaft of a motor 31 arranged inside the drive box 3a. According to this configuration, the drive box 3a integrated with the control box is mounted on an inner side of the door to be exposed therefrom, and the stopper 4a is directly connected to the shaft of the motor 31 to pivot or rotate within a predetermined angle. In this case, a plurality of location sensors (not shown) such as limit switches (to be electrically connected with a control circuit) are arranged at interference positions between the drive box 3a and the receiver 36 to control the rotation angle of the stopper 4a, thereby pivoting or rotating the stopper 4a within the predetermined angle.

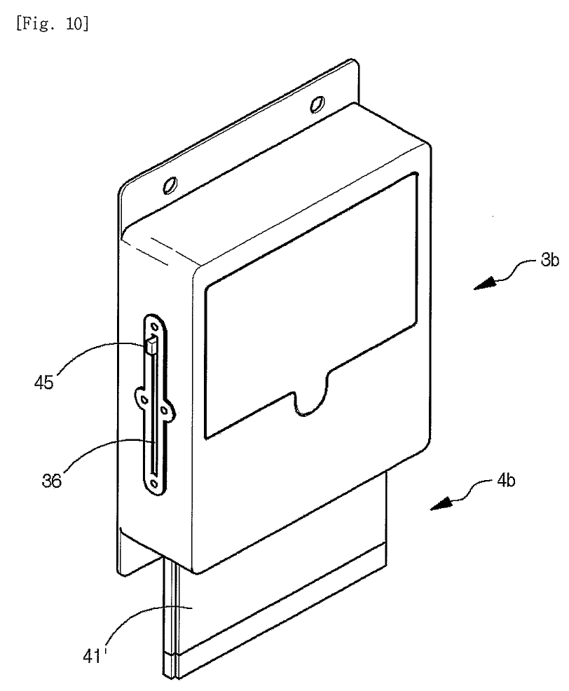

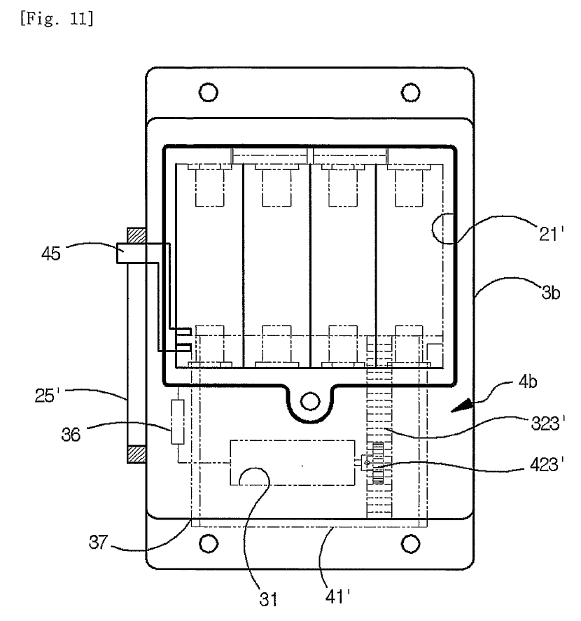

FIG. 10 is a perspective view illustrating an automatic door stopper apparatus having an integral structure of a control box and a drive box according to yet another embodiment of the invention; and FIG. 11 is a front configuration view illustrating the automatic door stopper apparatus having an integral structure of a control box and a drive box according to yet another embodiment of the invention.

Referring to FIGS. 10 and 11, this embodiment provides a control box integrated with a drive box 3b by arranging a battery unit 21′ and a circuit board 25′ inside the drive box 3b, and arranging a plate-shaped stopper 4b inside the drive box 3b. The stopper 4b has a rack 423′ formed on a plate-shaped body 411 thereof, which is meshed with a pinion 323′ formed on a shaft of a motor 31. A knob 45, in particular, for controlling raised and lowered positions of the stopper 4b is connected to one end of the stopper 4b, and a knob guide 36 for guiding the knob 45 is arranged at one portion of the drive box 3b. Furthermore, a guide hole 37 is perforated in the bottom of the drive box 3b to guide upward and downward movements of the stopper 4b. According to this configuration, the drive box 3b integrated with a control box is mounted on an inner side of the door to be exposed therefrom, and the plate-shaped stopper 4b is driven upward and downward by the rack 423′ and the pinion 323′ converting a rotational movement of the motor 31 into a linear movement.

### INDUSTRIAL APPLICABILITY

As set forth above, the door stopper apparatus of the invention can overcome difficulties of the prior art by operating the stopper in response to a simple operation of a user opening the door or pressing the control button. Accordingly, any people including the handicapped can easily use the door stopper apparatus of the invention. Furthermore, the elastic spring arranged in the stopper can further enhance the close contact between the door fixing member and the floor to advantageously prevent the door from being closed by the wind and so on. Moreover, the door stopper apparatus of the invention can be advantageously applied to not only a hinged door but also a glass door.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

What is claimed is:

1. An automatic door stopper apparatus comprising: a control box buried in an inner side of a door, the control box having a battery unit and a circuit board therein, the battery unit including a plurality of batteries arranged therein; an opening sensor arranged in a predetermined portion of the door and electrically connected to the circuit board; a drive box buried in the inner side of the door and electrically connected with the circuit board of the control board, the drive box driven by a motor which performs forward/backward rotation; and a stopper having a body having a split central portion and opposing first and second ends, a driven medium arranged at the first end of the body and connected to the drive medium, an elastic spring arranged inside the body, and a door fixing member arranged at the second end of the body.

2. The automatic door stopper apparatus according to claim 1, wherein the control box and the drive box are arranged on an inner side of the door to be exposed therefrom.

3. The automatic door stopper apparatus according to claim 1, wherein the drive medium comprises one selected from the group including a spur gear, a wire and a pinion, and wherein the driven medium comprises one selected from the group including a gear meshing with the spur gear, a connector connected with the wire and a rack meshing with the pinion.

4. The automatic door stopper apparatus according to claim 1, wherein the door comprises one selected from the group consisting of a hinged door, sliding door and a glass door, and wherein the battery unit and the circuit board are integrally arranged in the drive box.
